(19) United States
(12) Patent Application Publication
(10) Pub. No.: US 2009/0296535 A1
(43) Pub. Date: Dec. 3, 2009

(54) DEVICE CAPABLE OF RECORDING, STORING, MANIPULATING, AND TRANSFERRING INFORMATION

(75) Inventors: Scott A. Jones, Carmel, IN (US); Zhen Huang, Carmel, IN (US)

Correspondence Address: STAAS & HALSEY LLP, SUITE 700, 1201 NEW YORK AVENUE, N.W., WASHINGTON, DC, 20005, US

(73) Assignee: SAJE Holdings, Inc., Carmel, IN (US)

(21) Appl. No.: 12/477,678

(22) Filed: Jun. 3, 2009

Related U.S. Application Data
(60) Provisional application No. 61/058,437, filed on Jun. 3, 2008.

(51) Int. Cl. H04B 1/20

(52) U.S. Cl. 369/1

(57) ABSTRACT

A method, system and apparatus for continuously recording, selectively storing, manipulating, and transferring information is provided. An apparatus continuously captures a data input signal and selectively designates saved portions of the data input signal to store or archive in the system. A method and system identifies and controls a data input signal for continuously recording, selectively storing, manipulating and transferring information.

### CROSS-REFERENCE TO RELATED APPLICATIONS

This application is related to and claims the benefit of U.S. Provisional Application Ser. No. 61/058,437, by Scott A. Jones, et al., filed Jun. 3, 2008, entitled, “DEVICE CAPABLE OF RECORDING, STORING, MANIPULATING, AND TRANSFERRING INFORMATION”, in the United States Patent and Trademark Office, the disclosure of which is included herein in its entirety by reference.

### BACKGROUND

1. Field of the Invention

The present invention is related to a device, in particular a device capable of recording, storing, manipulating, and transferring information.

2. Description of the Related Art

In general, devices are narrowly tailored for performing singular functions. In particular, certain mobile devices can record audio, video, and/or text data, but are limited in their capabilities to additionally store, manipulate, and transfer any recorded data. For example, simple mimicking devices exist to record ones voice and allow subsequent playback of a recording. These devices are often limited to a minimal amount of internal memory storage. Storage on these devices without the capability of manipulation and/or transfer of the data limits the usefulness of such a device. These devices may be able to store or playback a recording in its entirety, but the manual and tedious interaction between a user and a device, such as setting a recording time before recording data, and/or being limited to the playback of the entirety of recorded data cannot be avoided to distill useful information from a lengthy data recording. The data storage methods on currently available devices require a significant amount of manual, prolonged and often continuous user input to for a desired result.

Such devices exist, such as tape recorders that allow recording or playback of audio by means of specific manual input by a user. For example, with a tape recording device, a user must activate various controls to record, stop, pause, and/or play an audio recording. A user may also initialize a recording schedule on a device, but a detailed schedule of information must be obtained before setup of a desired recording schedule for a device may occur. In such devices, a total recording time is limited by the size of memory storage. Additional information cannot be stored on a device when the associated data storage space is full or out of free data memory space. Current data storage space often limits the recording time from hours to minutes or even seconds. A user may also set a recording location in a device to overwrite previous information so that additional information can be recorded. However, interaction is required for a user to select a specific recording location. In general, the continuous recording of information cannot be achieved without detailed and often continuous interaction from a user. In addition, any continuous recording in these devices may be recorded and/or stored in its entirety, but such recordings do not provide an interface for a user to seek for intended information. The data or recorded information is often located in the same storage space. Without a useful tool such as a marker or other indicator, the data can only be continually recorded and then manually broadcasted to find the specified portion(s) of the recording. It is desirable for a device to continually record data such as audio or video, tag the data at certain time intervals, data segments, and/or any other defined portioning or segmenting, and allow playback of the portioned data. Portioning of the data may be defined automatically, for example, by device presets, portioning may be user defined by the use of user preferences or otherwise, and/or portioning may be defined by any other means associated with the device and/or the user.

Alternatively, there exist devices that implement digital video recording (DVR) technology that do not require manual user input at the specific time of recording, but do not allow continuous and/or automatic recording. Digital video recording requires a user to input information for recording and is limited by specific signal schedules and/or limitations of the video/audio signal source. Such limitations require these devices to be programmed to record specific requested data in advance of the occurrence of the specific data. For example, certain DVR devices allow a user to program the device to record a television signal in advance of the signal output, and subsequently playback the recording at a future time. However, these DVR devices do not allow a user to capture information presently, and playback previously captured data presently. It is desirable to have a device capable of capturing information continuously and/or at any specified intervals and/or in specified segments, portioning the information into any defined portioning, saving the information to a data storage medium and allowing playback and/or preset output of the past captured information defined by the portioning.

In a similar limitation, mobile devices are limited in their ability to transfer information to and/or from other devices. Mobile devices generally communicate with computers to transfer stored data directly. The availability of a computer limits the application of these devices. Data communication through a cell phone may provide an alternate means for data transfer. In particular, certain mobile devices exist that are capable of transferring information via a portable USB memory drive detachably contained in such a device. Transfer of information in this manner is inconvenient as a USB drive is a relatively large component for a mobile device. USB drives are also easy to lose and/or damage. In addition, transfer of information by this method requires physical connections to and/or from additional devices. Wireless technology exists for the quick transfer of information across a variety of networks to a variety of remote devices. Therefore, it is desirable for a mobile device to be integrated with any number of various forms of wireless technology in order to transfer recorded, stored, and/or manipulated information to a variety of remote devices.

In light of these limitations, a mobile device capable of continuously recording and storing information, along with the capability of manipulation of any portion of the information and subsequent ability to transfer the information to remote devices via wired and/or wireless transfer technology is desired. The device is capable to continuously record information, whereby a user can activate the device to segment and/or store portions of a recording, by, for example, periods of time that have already passed, but have been captured by the continuously recording device.

### SUMMARY

The present invention provides a user device or apparatus comprising an interface coupled with controller component. The controller component comprises a data storage medium, a database, a circular or ring buffer, a microprocessor, power source, and wireless receiver/transmitter component. The housing of the user device comprises a data capture or input unit, a data output unit, data transfer port, and a plurality of user controls. The housing may be coupled with a capacitive framing. The interface comprises one or more of a LCD, LED, OLED and/or touch screen type display.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is a block diagram of an exemplary system embodiment.

FIG. 2 is a block diagram of an exemplary system embodiment.

FIG. 3 illustrates a front view of an exemplary user device embodiment.

FIG. 4 illustrates a side view of an exemplary user device embodiment.

FIG. 5 illustrates a state diagram.

FIG. 6 illustrates a flow diagram of a system process.

FIG. 7 illustrates a flow diagram of a system process.

FIG. 8 illustrates a flow diagram of a system process.

FIG. 9 illustrates a flow diagram of a system process.

FIG. 10 illustrates a flow diagram of a system process.

### DETAILED DESCRIPTION OF THE PREFERRED EMBODIMENTS

Reference will now be made in detail to the present embodiments discussed herein, examples of which are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate.

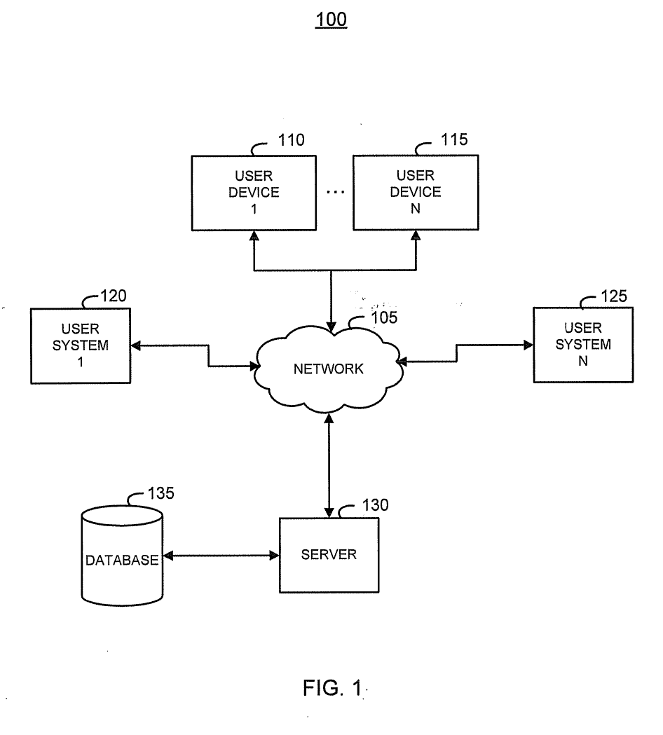

As illustrated in FIG. 1, a diagram of the system architecture 100 is provided. The system architecture 100 includes a network 105 such as the Internet, user device(s) 110, 115, user system(s) 120, 125, a system server 130, and a database 135.

A user system, a user device, and/or a system server may establish a communication session and/or send or receive data or information using wired and/or wireless technology such as Bluetooth® technology, ZigBee® technology, Internet through Wireless Application Protocol (WAP), Wi-Fi®, or any other type of communication. A connection may be established using any device which is capable of utilizing a communication system, process and/or service. For example, a user device, such as the user device 110 may establish a communication session with a user system(s), such as the user system 120, or another user device, such as the user device 115 using a Bluetooth® or WAP connection associated with the user device(s) 110 and/or 115 and/or the user system(s) 120, 125. A desktop, laptop or server system might be used to establish a communication session. A specialized communication terminal or any other communication method may be used to establish a communication session.

The network 105 may be a global public network of networks (the Internet) and/or consist in whole or in part of one or more private networks and communicatively couples the user device(s) 110, 115, the user system(s) 120, 125, with the other components of the system such as the system server 130, and the database 135. The network 105 may consist of any available wired and/or wireless communication technologies currently available.

A system database 135 is provided which may include records which indicate data associated with a user system(s) or user device(s) associated with a user and/or any information associated with a user and/or the user system(s) or device(s). For example, the system database 135 may include data transferred from a user device and/or information associated with user preferences and/or other information associated with a user device. The system server 130 may allow and/or facilitate interaction to occur among the user systems 120, 125, the user devices 110, 115, and/or the database 135. For example, a segment of audio and/or video data may be transferred from the user device(s) 110, 115 to the user system(s) 120, 125 and/or to the system server 130, where it can be stored and/or accessed by the user system(s) 120, 125, the system server 130, and/or additional user device(s) 110, 115.

The system server 130 is communicatively coupled with the database 135. The database 135 includes data that is processed in association with operation(s) of the embodiments. Although FIG. 1 illustrates the database 135 as a separate component of the system, the database 135 may be integrated with the server system 130 and/or the user systems 120, 125. Further, the data records maintained in the database 135 may be stored in any typical manner, including in a Network Attached Storage (NAS), a Storage Area Network (SAN), etc. using any typical or proprietary database software such as DB2®, Informix®, Microsoft® SQLServer™, MySQL®, Oracle®, etc., and may also be a distributed database on more than one server. Elements of the database 135 may reside in any suitable elements of the system 100.

Any user system (e.g., the user systems 120, 125) can be operated by a user, who may be a person, to download, store, access and/or manipulate data and/or allow information to be sent and/or received through the system server 130. Any user device (e.g., the user devices 110, 115) can be operated by a person, or may alternatively be wholly or partially automated system(s) used to capture, store, manipulate, broadcast, send and/or receive auxiliary information and provide and/or obtain any data utilizing a user system (e.g., the user systems 120, 125), the system server 130 and/or the database 135. The user systems 120, 125 and/or the user devices 110, 115 may not be accessible using the network 105. For example, a user device, such as the user device 110, may be accessible to a user operating a user system such as the user system 120.

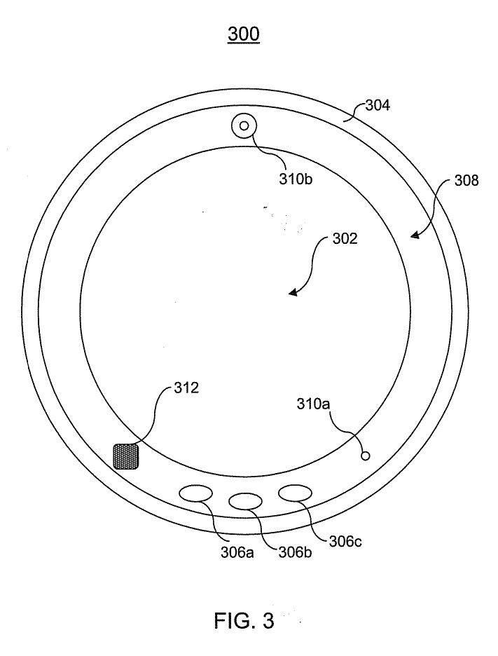

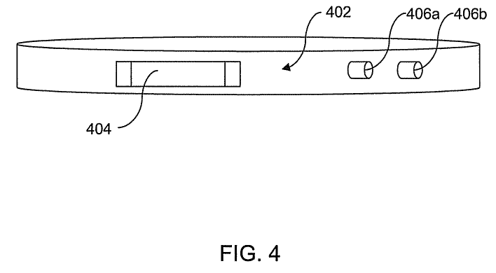

A user system may be a desktop or portable computer, a mobile phone, a smart phone, a personal digital assistant (PDA), a server system, a specialized communication terminal, a work station or a terminal connected to a mainframe, or any other communication device through which data can be sent and/or received. The user device, such as 110, 115, explained further herein with respect to FIGS. 3 and 4, may be provided as mobile communication device implemented as a wristwatch, armband, or other similar mobile device. However, the device is not limited to implementation as a stand-alone device. In addition, the device may be implemented as an incorporation into other mobile devices. For example, the device may be resident in, or otherwise associated with an existing cellular phone, a PDA, and/or may be embodied as any mobile device. The system server 130 may include one or more servers, computers, etc. After being presented with the disclosure herein, one of ordinary skill in the relevant art will immediately realize that any viable computer system(s) or communication device(s) known in the art may be used as user systems and/or user devices to implement the system 100.

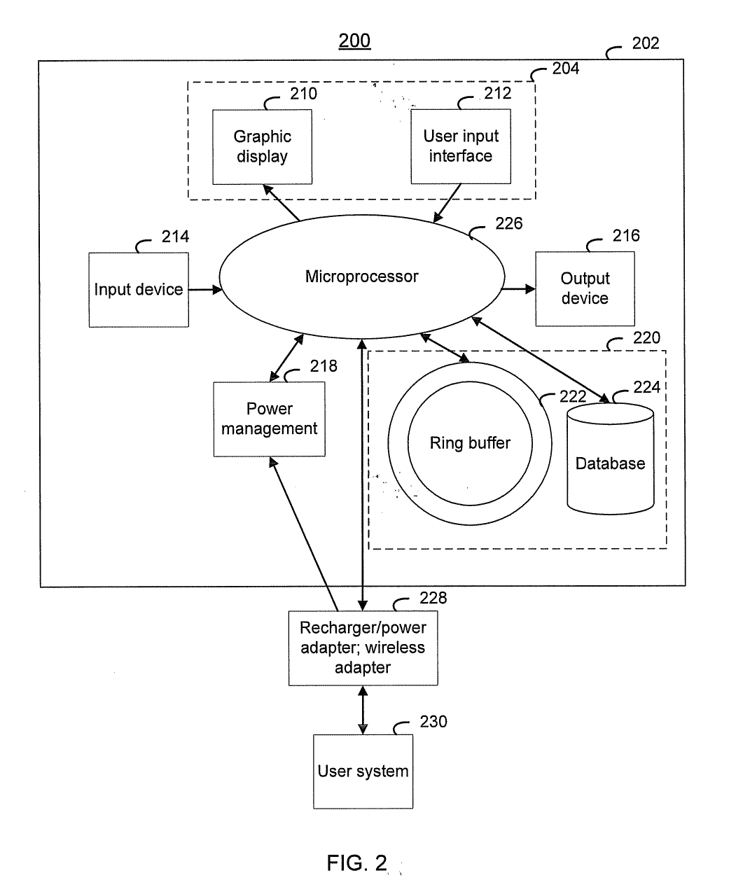

As illustrated in FIG. 2, system 200 includes a user device 202 which may include a user interface component or graphical user interface (GUI) component 204, input component 214, output component 216, power management component 218, data structure component 220, microprocessor 226, power supply component 228, and user system 230.

The user device or apparatus 202 includes the components for operation. The user interface component 204 may include a display 210 and/or a user input interface 212.

The display 210 may be implemented as an LED, LCD, and/or OLED display and/or may be coupled with the user input interface 212 as embodied as a touch screen and/or other type of display and/or interface display. The display 210 may be a text and/or graphic display and may be provided as a non-color and/or a color display which may include various auxiliary outputs such as time, date, temperature, speed, direction, etc. Any outputs on the display 210 may be internally provided presets on the user device 202 and/or may be user inputs either directly provided to the device, by, for example, utilizing the user input interface 212, and/or remotely provided via transfer of information to the user device 202, by for example, the user system 230. For example, an output on the display 210 may be a time of day provided by an internal clock of the user device 202, and/or an output may be a portion of text transferred to the user device 202 from the user system 230. In addition, information provided via the display 210 may be derived from internal and/or external readings and/or computations as performed by the user device 202. For example, the user device 202 may be capable of reading an external temperature of the atmosphere, computing a conversion of the temperature into various units, and displaying the converted temperature reading as an output on the display 210. The display 210 may be coupled with the user input interface 212, by for example, implementing touch screen technology to facilitate any user input. Alternatively, a capacitive framing may be provided around the user input interface 212 and/or incorporated in the user input interface 212 to facilitate user control of the device 202.

The user input interface 212 may contain a plurality of user controls to facilitate user input. The user controls may be implemented as buttons, dials, thumbwheels, and/or any other type of user control. The user controls may allow a user to control specific aspects of performing a recording utilizing the user device 202. For example, the user controls of the user input interface 212 may be implemented as certain presets of time. A preset of time may be 30 seconds, one minute, or any other interval of time. Using the user controls implemented as presets of time, for example, a user may be able to navigate directly to a certain location in a recording that correlates to the user selected control. For example, a user may capture data continuously, and upon selecting a user control of “30 seconds”, activate the user device 202 through the user input interface 212 to determine and then output any information captured 30 seconds prior to the activation of the user control and/or may activate the user device 202 to capture any 30 second window of continuously recorded data. The user device 202 may alternatively capture any information at a certain preset automatically, or by activation of any user controls of the user input interface 212. For example, a user may desire to only capture data every 30 seconds, and for example, by selecting a user control of “30 seconds”, a user may activate the device to capture information at 30 second intervals and/or activate the device to capture any 30 second segment of continuously recorded data. The user input interface 212 may allow manipulation of any recording, and/or facilitate the storage, transfer, and/or broadcast of any recording associated with the user device 202.

The user device 202 may contain the input component 214 and/or the output component 216. The input component 214 and/or the output component 216 may be alternatively associated with the user interface component 204 of the device, incorporated into the user interface component 204, and/or internally held resident in the user device 202, etc. The input component 214 may be implemented as a non-directional microphone, a camera and/or video lens of any receiving angle(s), etc. The input component 214 may be resident on or in the user device 202. Implemented as a non-directional microphone, the input component 214 may allow recording of voice, and/or capture or recording of any various audio or sounds. The input component 214 may be alternatively or additionally implemented as a lens, such as a camera lens and/or a video lens that may facilitate recording of any various static and/or animated images, video and/or sound. The input component 214 may allow capture and/or recording of data at specified and/or automatic time intervals. For example, the user device 202 may be activated by the user input interface 212 or otherwise to facilitate activation of the input component 214 to record audio every 30 seconds, or the device may be activated to record a static image(s) at five minute intervals via the input component 212, etc.

To facilitate broadcast or playback of a recording and/or any audio, video, and any other files associated with the user device 202, an output component 216 may be provided as associated with the user device 202. The output component 216 may be implemented as a speaker, a headphone jack, a display, such as a video screen, and/or any other output means that may be provided to facilitate playback of any data associated with the user device 202. For example, the output component 216 may be implemented as a speaker that allows playback of audio recordings captured by the input component 214. The output component 216 may output information or data based on activation of any user controls as provided associated with the interface component 204. For example, using a user control associated with the user input interface 212, a user may activate the user device 202 to determine any portion of information captured at any time in the past and output the information via the output component 216 accordingly.

The microprocessor 226 provides for information manipulation, processing, and transfer. The microprocessor 226 is communicatively coupled with the user interface component 204, the input component 214, the output component 216, power management component 218 and the data structure component 220. Utilizing the microprocessor 226 and/or the data structure component 220, automatic or manual markers may be implemented in data segments, portions and/or files, in particular, in segments of data embodied as audio recordings, to facilitate ‘skipping’ from one segment or portion or time to another within an audio recording or data file.

The data structure component 220 may include the circular buffer 222 and the database 224. The circular buffer or ring buffer 222 may provide for the temporary storage of data or information as captured or retrieved by the input component 214, and/or may facilitate sending data or information to the output component 216 of the user device 202. The circular buffer 222 may include any number of markers or pointers to point to the buffer in the memory and/or any start or beginning and/or end in any data recorded to the circular buffer 222. The circular buffer may be used to temporarily record and/or store information as specified manually, automatically, or otherwise by utilization of the user interface component 204. The circular buffer 222 may be communicatively coupled to the database 224 to send and/or transfer data or information to the database 224.

The database or data storage medium (DSM) 224 may provide for the storing, temporary or otherwise, of any data or files associated with the user device 202. For example, audio recordings may be saved as audio files in any viable format, such as MP3 format, originally in the circular buffer 222 of the user device 202, and/or in the database 224. In addition, any recordings and subsequent audio files may be saved to remote and/or removable memory storage media, or may be transferred to a remote device(s), such as the user system 230. The database 224 may include any information associated with the user device 202, including, for example, information associated with the function and/or performance of the user device 202, and/or any other data that may be associated with the user device 202, associated devices, such as the user system 230, and/or the user. The information contained in the database 224 may include preset information, stored information, function information, user input information, etc. The device may derive energy from a power management component 218 which may be implemented as a plurality of batteries that are capable of being recharged.

Data associated with the circular buffer 222 and/or the database 224 may be sent and/or transferred to the user system 230 via any available auxiliary network, wireless adapter, and/or any wired or wireless auxiliary communication component 228. Any data, including audio, text, video files, etc., may be stored internally on the user device 202 in the circular buffer 222 and/or the database or DSM 224. Any data may be stored on a removable storage device such as a flash memory card and/or USB drive, or a user system 230 which may be any computer, CPU or other data processing unit capable of connection with the user device 202 by any means, for example, via the communication component 228.

The communication component 228 may be a wireless receiver/transmitter component that may provide the user device 202 the capability to communicate with other communication devices such as a computer, mobile phone, etc. The wireless technology may be Bluetooth® technology, ZigBee® technology, Wi-Fi®, or any other means of wireless communication technology. The wireless receiver/transmitter may facilitate the transfer of data files, including text, video, audio, etc., from the user device 202 to a remote device, such as the user system 230, and vice versa. The wireless receiver/transmitter may also provide the capability of the user device or apparatus 202 to serve as a medium of communication. Using the user device 202 as an intermediate, a user may be able to communicate with or otherwise connect to a remote device and thus be able to access and/or utilize the remote devices' system. In at least one embodiment, the user device 202 may connect to and/or be capable of controlling or accessing a mobile or cellular phone. Data transfer and/or communication may not be limited to wireless technology as wireless technology, two-way communication, wired input connections, such as a USB port, or other means for communication may be used. Data transfer from the user device 202 to a receiving device may be possible via any of the methods of communication as previously mentioned in order to send data in any form and/or messages such as emails, text messages, picture messages, etc. In at least one embodiment, a method of data transfer associated with the user device 202 may include data sync with a remote device.

FIG. 3 illustrates an exemplary embodiment 300 of the user device or apparatus. The user device may be provided as a device or mobile device implemented as a wristwatch, armband, necklace, or any other embodiment of a mobile device unit. However, the user device is not limited to implementation as a stand-alone device as the user device may be implemented as an incorporation into other devices or mobile devices. For example, the user device may be resident in, or incorporated with an existing cellular phone, a PDA, and/or any other mobile device.

As illustrated in FIG. 3, the user device includes a display 302, a capacitive framing 304, user controls 306, housing 308, inputs 310 and output 312. The display 302 may be implemented as an LED, LCD, OLED, touch screen and/or any other type of display. The display 302 may output or display information to a user as well as take input from a user, by for example if the display 302 is embodied as a touch screen display or other user interface. The capacitive framing 304 may be provided for user interaction with the user device. The capacitive framing 304 may be provided around the display 302, the housing 308, or otherwise and/or incorporated in the display 302 to facilitate user control of the user device.

The user device may contain a plurality of user controls 306 to facilitate user input. The user controls 306 may be implemented as buttons, dials, thumbwheels, and/or any other embodiment that may be resident on the user device such as located on the device housing 308, or may be alternatively placed on and/or in the user device. The user controls 306 may allow a user to control specific aspects of recorded data such as certain presets of time. For example, user control 306a may be associated with a preset time of 30 seconds. If a user selects the user control 306a, a segment of data may be captured by the user device for the period of 30 seconds. The user controls may additionally allow for input or output of data. For example, the user control 306b may initialize a recording if selected and/or user control 306c may initialize the playback or broadcast of any stored data. The user controls 306 may have any number of functions associated with any number of controls.

The inputs 310 may be embodied as a non-directional microphone, such as the input 310a, and/or a camera or video lens, such as the input 310b. To facilitate playback or broadcast of a recording and/or any audio, video, and any other files associated with the user device, the output 312 may be provided on or in the device. As illustrated in FIG. 3, the output 312 may be implemented as a speaker, but the output may be implemented as a headphone jack, a display screen, a wireless channel and/or any other output means that may be provided to facilitate playback of any data associated with the user device.

FIG. 4 illustrates a side view exemplary embodiment of the user device or apparatus. As illustrated in FIG. 4, the device may include side housing 402, data transfer port 404 and a plurality of user controls 406. The side housing 402 may be any material that is used to encase or give form to the user device. The data transfer port 404 may be a USB, mini USB, or any other type of port which is capable of facilitating wired data transfer. The user controls 406 may be any number of controls that may be utilized for input, transferring, sending and/or receiving of information to and/or from the user device, and/or manipulation of data associated with the device, etc. The user controls 406 may be implemented as buttons, dials, thumbwheels, and/or any other type of user control.

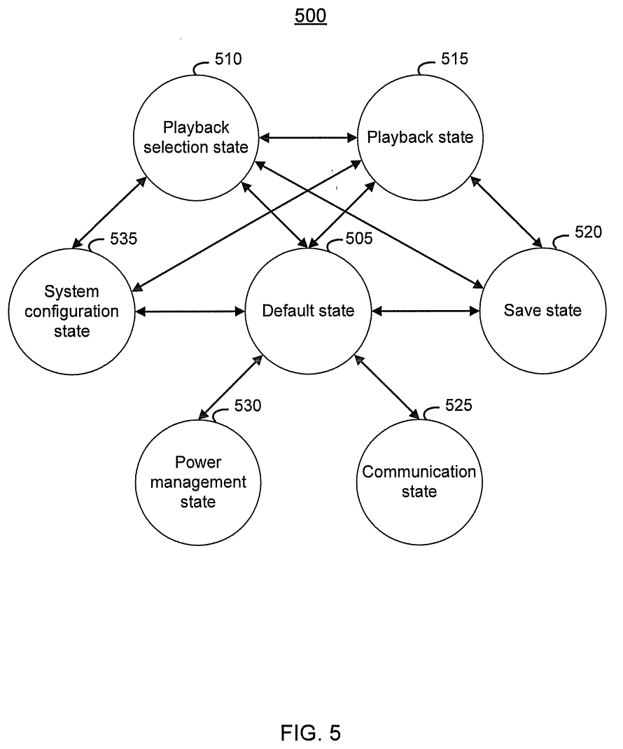

In FIG. 5, the system structure 500, illustrating the potential operation states of the user device is shown. As illustrated in FIG. 5, the operation states include a default state 505, a playback selection state 510, a playback state 515, a save state 520, a communication state 525, a power management state 530, and a system configuration state 535.

The default state 505 is the main or default function of the user device. For example, if the user device is embodied as a wristwatch, the default state 505 may be implemented as a digital and/or analog display of a current clock time. Alternatively, the default state 505 may be illustrated on the user device as a display indicating a current status or function of the user device. The default state 505 may be changed to the playback selection state 510 if a user control is selected or any other triggering event occurs.

The playback selection state 510 may include any event(s) associated with the selection of user controls of the user device to browse to recorded or stored information contained in the circular buffer and/or the database or DSM of the user device. In the playback selection state 510, input from a user may be used to facilitate information associated with the circular buffer or DSM associated with the user device. Information or data contained in the circular buffer may be transferred to the DSM in the playback selection state 510 to ensure that information contained on the circular buffer is transferred to an alternative location prior to an overwriting event occurring on the circular buffer. The unit or segment or portion associated with the playback of data may be defined in the playback selection state 510, or may alternatively be defined as a system default or parameter defined in the system configuration state 535 or otherwise defined. The playback selection state 510 may be changed to the playback state 515 at any stage of the playback selection state 510 if a user control is selected or any other triggering event occurs.

The playback state 515 may include any event(s) associated with viewing, manipulating or otherwise playing, broadcasting or outputting data associated with the user device. The playback state may utilize any input or output components associated with the user device. For example, an output component such as a speaker, wireless transmitter, or display screen may be utilized to play and/or transfer audio, video and/or other data associated with the user device. The playback state 515 may be changed to the save state 520 at any stage of the playback state 515 if a user control is selected or any other triggering event occurs.

The save state 520 may include any event(s) associated with transferring, manipulating and/or saving data associated with the circular buffer and/or the DSM associated with the user device. For example, in the save state 520, data on the circular buffer may be transferred to a DSM associated with the user device to ensure a prolonged storage of the data prior to an overwriting event occurring on the circular buffer. Parameters or functions associated with segments or portions of data associated with the functions of the save state 520 may be user and/or system defined. For example, segments or portions of data such as a currently recorded segment of audio data and a next and/or previous segment of audio data may be automatically saved as a group of data directly from the circular buffer to the DSM per a predefined saving parameter. Data manipulation functions may be included in the save state 520 such as the capability to name, rename, delete, move, save to, save as, etc. a portion of data or data file. The save state 520 may be changed to the communication state 525 at any stage of the save state 520 if a user control is selected or any other triggering event occurs.

The communication state 525 may include any event(s) associated with the communication among the user device and any auxiliary devices and/or any other systems. For example, a wireless or wired communication event may occur via any available communication connection to facilitate the transferring of data to and from the user device. The communication state 525 may utilize any software associated with setting system or device parameters, manipulating data associated with the data structure of the user device and/or transferring data between the user device and a user system or any other external data storage device or system. A controller or other capable device, adapter, or charger may operate as a mediator to facilitate communication during the communication state 525. The communication state 525 may be changed to the power management state 530 at any stage of the communication state 525 if a user control is selected or any other triggering event occurs.

The power management state 530 may include any event(s) associated with the power necessary to operate the user device. For example, the power management state 530 may include an interface for viewing a current power status of the user device, such as a power consumption meter, battery life remaining icon, etc. The power management state 530 may include automatic functions of the user device such as switching from a primary source of power to an auxiliary source of power as necessary to maintain operating function of the user device, recharging a battery, providing power consumption notifications or suggestions, etc. The power management state 530 may be changed to the system configuration state 535 at any stage of the power management state 530 if a user control is selected or any other triggering event occurs.

The system configuration state 535 may include any event(s) associated with the configuration or manipulation of the user device and/or system functions or parameters. For example, selection of any user controls associated with a user device may provide for manipulation of a recording file size, file extension, playback mode, scheduling events or functions, etc. Alternatively, system features such as preferred data transfer means or methods may be set as parameters in the system configuration state 535. Selection of user controls to perform functions in the system configuration state 535 may be facilitated by software associated with the user device, may occur via manual or tactile selection of user controls, through voice activation or other control, whether manual, automatic, remote control or otherwise. The system configuration state 535 may be changed to another state at any stage of the system configuration state 535 is a user control is selected or any other triggering event occurs. While the process of changing states in the system configuration 500 was defined in a certain path, any state associated with the system configuration 500 may change to another state in the system configuration 500 in any order and/or at any stage in a certain state.

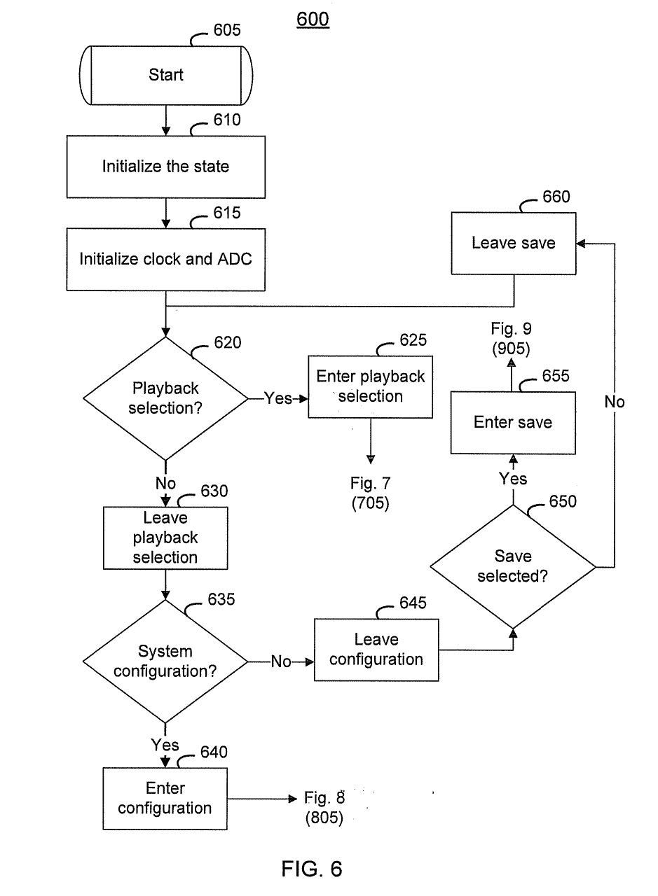

As illustrated in FIG. 6, a process 600 for executing program code on a user device is provided. In operation 605, the program code is executed and the process 600 begins. In operation 605, the user device may be supplied power and able to be powered on to the default state 505 (FIG. 5). Control is passed to operation 610 and process 600 continues.

In operation 610, an initialization procedure occurs. For example, a current power availability or battery status may be automatically checked to determine a next step. Additionally, in operation 610, system or user device parameters may be retrieved from memory or if powering on of the device did not occur in operation 605, non-volatile memory, such as read-only or flash memory and/or EEPROM, associated with the user device. Alternatively, a secondary battery or other power source may provide that an amount of power is continually supplied to drive a real-time clock (RTC) or other function(s) running on a microprocessor of a user device. Initialization to the default state 505 may depend on the power supply associated with the components of the user device. For example, if insufficient power is available to execute the functions associated with the default state 505, or any other state associated with the user device, the state may not be initialized. Control is passed to operation 615 and process 600 continues.

In operation 615, auxiliary initialization procedures occur. For example, an analog-to-digital converter (ADC) module associated with the user device may be initialized to perform a conversion and subsequent recognition of a voice activation command operating as a user control of the user device. Additionally, a hard reset or system failure of the user device may result in the initialization procedure of a restoring a default or manufacturer state of the RTC, timer and/or other functions of the user device to occur. Control is passed to operation 620 and process 600 continues.

In operation 620, a determination is made as to whether a user control is selected or any other triggering event associated with initializing the playback selection state 510 (FIG. 5) of the user device occurs. If in operation 620 it is determined that a user control is selected, control is passed to operation 625. The determination of operation 620 may be based on several factors. For example, a user control such as a button, switch, voice activation command, or otherwise may be executed to change a current state of the user device to the playback selection state 510. If it is determined in operation 620 that a user control is not selected, control is passed to operation 630 and process 600 continues.

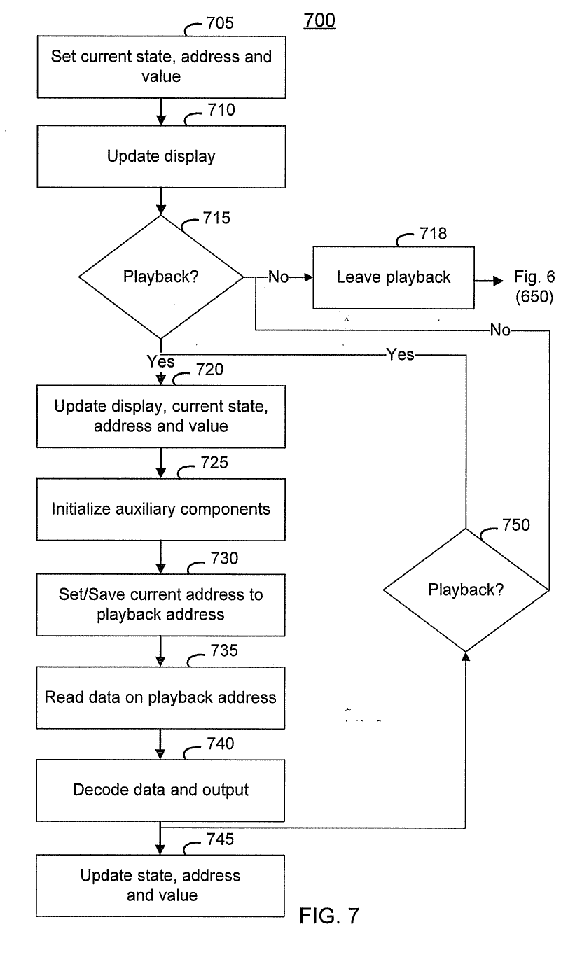

In operation 625, the function of the user device is directed to the playback selection state 510 (FIG. 5). Control is passed to operation 705 (FIG. 7) and process 700 continues.

In operation 630, the function of the user device is directed away from the playback selection state 510. For example, if no user control is selected in operation 620, the user device may operate a time-out function that returns the user device function to a previous state and/or directs the user device function to the default state 505 (FIG. 5). Alternatively, a user control associated with leaving the playback selection state 510 may be selected in operation 620 (FIG. 6), such as, by example, a selection of an ‘exit’ or ‘cancel’ control, that may return the user device function to a previous state and/or direct the user device function to the default state 505 (FIG. 5). In another alternative, operation 630 may not direct away from the playback selection state 510, but may wait at the playback selection state 510 and continue to wait until a selection occurs. Control is passed to operation 635 and process 600 continues.

In operation 635, a determination is made as to whether a user control is selected or any other triggering event associated with initializing the system configuration state 535 (FIG. 5) of the user device occurs. If in operation 635 it is determined that a user control is selected, control is passed to operation 640. The determination of operation 635 may be based on several factors. For example, a user control such as a button, switch, voice activation command, or otherwise may be executed to change a current state of the user device to the system configuration state 535 (FIG. 5). If it is determined in operation 635 that a user control is not selected, control is passed to operation 645 and process 600 continues.

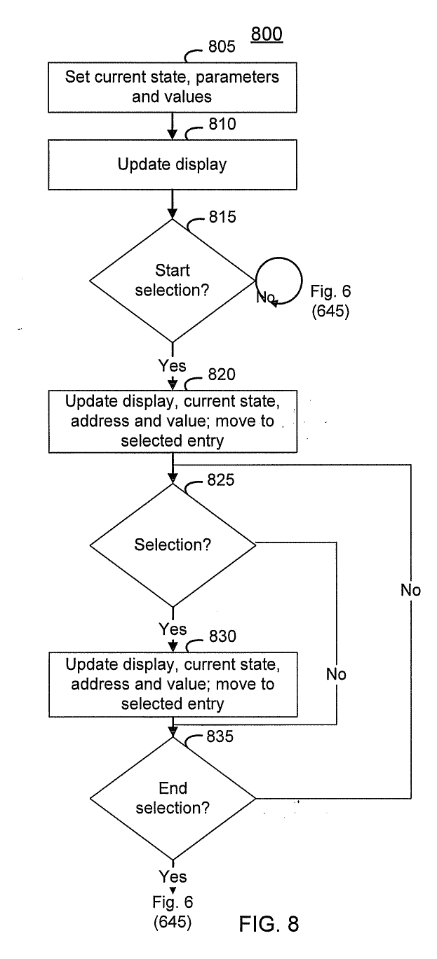

In operation 640, the function of the user device is directed to the system configuration state 535 (FIG. 5). Control is passed to operation 805 (FIG. 8) and process 800 continues.

In operation 645, the function of the user device is directed away from the system configuration state 535. For example, if no user control is selected in operation 635, the user device may operate a time-out function that returns the user device function to a previous state and/or directs the user device function to the default state 505 (FIG. 5). Alternatively, a user control associated with leaving the system configuration state 535 may be selected in operation 635 (FIG. 6), such as, by example, a selection of an ‘exit’ or ‘cancel’ control, that may return the user device function to a previous state and/or direct the user device function to the default state 505 (FIG. 5). In another alternative, operation 645 may not direct away from the system configuration state 535, but may wait at the system configuration state 535, or any other state and continue to wait until a selection occurs. Control is passed to operation 650 and process 600 continues.

In operation 650, a determination is made as to whether a user control is selected or any other triggering event associated with initializing the save state 520 (FIG. 5) of the user device occurs. If in operation 650 it is determined that a user control is selected, control is passed to operation 655. The determination of operation 650 may be based on several factors. For example, a user control such as a button, switch, voice activation command, or otherwise may be executed to change a current state of the user device to the save state 520 (FIG. 5). If it is determined in operation 650 that a user control is not selected, control is passed to operation 660 and process 600 continues.

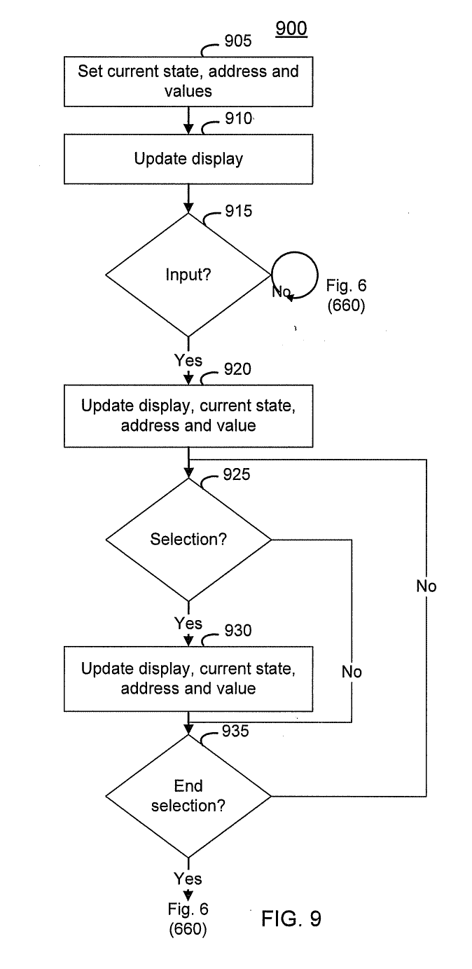

In operation 655, the function of the user device is directed to the save state 520 (FIG. 5). Control is passed to operation 905 (FIG. 9) and process 900 continues.

In operation 660, the function of the user device is directed away from the save state 520 (FIG. 5). For example, if no user control is selected in operation 650, the user device may operate a time-out function that returns the user device function to a previous state and/or directs the user device function to the default state 505 (FIG. 5). Alternatively, a user control associated with leaving the save state 520 may be selected in operation 660 (FIG. 6), such as, by example, a selection of an ‘exit’ or ‘cancel’ control, that may return the user device function to a previous state and/or direct the user device function to the default state 505 (FIG. 5). In another alternative, operation 660 may not direct away from the save state 520, but may wait at the save state 520, or any other state and continue to wait until a selection occurs. Control is passed to operation 620 and process 600 continues.

As illustrated in FIG. 7, a process 700 for executing any functions associated with the playback selection state 510 (FIG. 5) of a user device is provided. In operation 705 (FIG. 7), a flag or other indicator of the current state of the user device may be set to indicate the status of the playback selection state 510 (FIG. 5) and any associated current address or value. For example, a playback initialization point may be set to a current address with a value given as the ending point in a previous playback session or current location of a saving pointer or other indicator. Control is passed to operation 710 and process 700 continues.

In operation 710, any display and/or interface associated with the playback selection state 510 (FIG. 5) may be updated. For example, user controls associated with the playback selection state 510, such as user controls that may facilitate the execution of functions such as starting, stopping and/or saving a recording of data, may be displayed on the user device. In addition, user controls that may facilitate the execution of functions such as the manipulation of data by fast forwarding, rewinding, pausing, or any other user controls may be provided. Alternatively, user controls associated with leaving the playback selection state 510 may be provided in operation 710 (FIG. 7), such as, for example, an ‘exit’ or ‘cancel’ control, that if selected may return the user device function to a previous state and/or direct the user device function to the default state 505 (FIG. 5). Control is passed to operation 715 and process 700 continues.

In operation 715, a determination is made as to whether a user control is selected or any other triggering event associated with initializing the playback state 515 (FIG. 5) of the user device occurs. If in operation 715 it is determined that a user control is selected, control is passed to operation 720. The determination of operation 715 may be based on several factors. For example, a user control such as a button, switch, voice activation command, or otherwise may be executed to change a current state of the user device to the playback state 515 (FIG. 5). If it is determined in operation 715 that a user control is not selected, control is passed to operation 718 and process 600 continues.

In operation 718, the function of the user device is directed away from the playback state 515 (FIG. 5). For example, if no user control is selected in operation 715, the user device may operate a time-out function that returns the user device function to a previous state and/or directs the user device function to the default state 505 (FIG. 5). In addition, if no user control is selected in operation 715, the user device may operate an automatic playback function that may execute the playback of a previous recording(s) in any order as defined, selected and/or playback recordings or any data from the current and/or previous starting or ending pointer of a particular segment of data. Alternatively, a user control associated with leaving the playback state 515 may be selected in operation 715 (FIG. 7), such as, by example, a selection of an ‘exit’ or ‘cancel’ control, that may return the user device function to a previous state and/or direct the user device function to the default state 505 (FIG. 5). In another alternative, operation 718 may not direct away from the playback state 515, but may wait at the playback state 515, or any other state and continue to wait until a selection occurs. Control is passed to operation 650 and process 600 continues.

In operation 720 (FIG. 7), any display and/or interface, current state, address and/or value associated with the playback selection state 510 (FIG. 5) may be updated. For example, user controls associated with the playback selection state 510, such as user controls that may facilitate the execution of functions such as starting, stopping and/or saving a recording of data, may be displayed on the user device. In addition, a user device may display the current status of playback, by for example displaying any information associated with a captured or recording segment of data. For example, any parameters associated with an audio recording selected for playback in operation 715 may be displayed, which may include a title or name of the audio file, which may be a default name, a total time duration, etc. Alternatively, user controls associated with leaving, pausing and/stopping the current function of the playback state 515 may be provided in operation 720 (FIG. 7), such as, for example, an ‘exit’ or ‘cancel’ control, that if selected may return the user device function to a previous state location and/or direct the user device function to the default state 505 (FIG. 5). A flag or other indicator of the current state of the user device may be set to indicate the status of the playback state 515 and any associated current address or value. For example, a playback initialization point may be set to a current address with a value given as the ending point in a previous playback session or current location of a saving pointer or other indicator. Control is passed to operation 725 and process 700 continues.

In operation 725, auxiliary initialization procedures occur. For example, an ADC module associated with the user device may be initialized to perform a conversion and subsequent recognition of a voice activation command operating as a user control of the user device, and/or to perform any conversion of voice or other audio that may be associated with a recording selected for playback in operation 715 as necessary for playback output, by for example via a speaker located on the user device. Control is passed to operation 730 and process 700 continues.

In operation 730, the current address and/or associated value is set to the current playback address. For example, the current address for the playback starting point or initial address as initialized in operation 715 is set to the current playback address, which may be subsequently updated to if additional recordings or segments of data are selected for playback. The current playback address may serve as the starting point or initial address for execution of functions associated with the save state 520 (FIG. 5). Control is passed to operation 735 and process 700 continues.

In operation 735, data is read from the playback address. In operation 735, the playback address may be a location associated with the circular buffer of the user device. Data may be retrieved from the playback address and read, converted, and/or sent to an output of the user device, etc. Control is passed to operation 740 and process 700 continues.

In operation 740, data is decoded or deciphered from the playback address. In operation 740, the playback address may be a location associated with the circular buffer of the user device. Data that may be encoded may be decoded or deciphered and sent to an output of the user device. Control is passed to operation 745 and process 700 continues.

In operation 745, the playback address and/or associated value is set to the current address. For example, the current address for the playback starting point or initial address as initialized in operation 715 is set to a current playback address, which may be subsequently updated to point to different data if additional recordings or segments of data are selected for playback. The updated current address may serve as the starting point or initial address for execution of functions associated with the save state 520 (FIG. 5) and/or subsequent functions executed in the playback state 515 (FIG. 5). Control is passed to operation 750 and process 700 continues.

In operation 750, a determination is made as to whether a user control is selected or any other triggering event associated with executing a function associated with the playback state 515 (FIG. 5) of the user device occurs. If in operation 750 it is determined that a user control is selected, control is passed to operation 720 and process 700 continues. The determination of operation 750 may be based on several factors. For example, a user control such as a button, switch, voice activation command, or otherwise may be selected to execute a function associated with the playback state 515 (FIG. 5). If it is determined in operation 750 that a user control is not selected, control is passed to operation 718 and process 700 continues. Alternatively, a user control associated with leaving the playback state 515 may be selected in operation 750 (FIG. 7), such as, for example, by a selection of an ‘exit’ or ‘cancel’ control, that may return the user device function to a previous state and/or direct the user device function to the default state 505 (FIG. 5).

As illustrated in FIG. 8, a process 800 for executing any functions associated with the system configuration state 535 (FIG. 5) of a user device is provided. In operation 805, a flag or other indicator of the current state of the user device may be set to indicate the status of the system configuration state 535 and any associated current addresses or values. For example, a current system configuration point may be set which may include any current set of parameters with any values or current location of a saving pointer or other indicator. Control is passed to operation 810 and process 800 continues.

In operation 810, any display and/or interface associated with the system configuration state 535 (FIG. 5) may be updated. For example, user controls associated with the system configuration state 535, such as user controls that may facilitate the execution of functions such as selecting and/or changing system parameters may be displayed on the user device. In addition, system parameters and/or any other data may be displayed. Control is passed to operation 815 and process 800 continues.

In operation 815, a determination is made as to whether a user control is selected or any other triggering event associated with initializing the system configuration state 535 (FIG. 5) of the user device occurs. If in operation 815 it is determined that a user control is selected, control is passed to operation 820. The determination of operation 815 may be based on several factors. For example, a user control such as a button, switch, voice activation command, or otherwise may be utilized to select any parameter of the system configuration state 535 of the user device. If it is determined in operation 815 that a user control is not selected, control is passed to operation 645 (FIG. 6) and process 600 continues. In an alternative, if it is determined in operation 815 that a user control is not selected, control may not direct away from the system configuration state 535, but may wait at the system configuration state 535 or any other state and continue to wait until a selection occurs.

In operation 820, any display and/or interface, current state, address and/or value associated with the system configuration state 535 (FIG. 5) may be updated. For example, user controls associated with the system configuration state 535, may be displayed on the user device. In addition, a user device may display the current status of a user control selection, by for example, displaying any information associated with a selected data parameter of the user device system. For example, any parameters associated with an audio recording playback may be displayed, which may include a data title or name parameter, preset or predetermined duration of time associated with data capture or recording parameters, etc. A flag or other indicator or pointer of the current state of the user device may be set to indicate the status of any selections associated with the system configuration state 535 and any associated current address or value. Control is passed to operation 825 and process 800 continues.

In operation 825, a determination is made as to whether a user control is selected or any other triggering event associated with executing a function associated with the system configuration state 535 (FIG. 5) of the user device occurs. If in operation 825 it is determined that a user control is selected, control is passed to operation 830 and process 800 continues. The determination of operation 825 may be based on several factors. For example, a user control such as a button, switch, voice activation command, or otherwise may be utilized to select any parameter of the system configuration state 535 of the user device. If it is determined in operation 825 that a user control is not selected, control is passed to operation 835 and process 800 continues. Alternatively, a user control associated with leaving the system configuration state 535 may be selected, such as, for example, by a selection of an ‘exit’ or ‘cancel’ control, that may return the user device function to a previous state and/or direct the user device function to the default state 505 (FIG. 5).

In operation 830, any display and/or interface, current state, address and/or value associated with the system configuration state 535 (FIG. 5) may be updated. For example, user controls associated with the system configuration state 535, may be displayed on the user device. In addition, a user device may display the current status of a user control selection, by for example displaying any information associated with a selected data parameter of the user device system. For example, any parameters associated with an audio recording playback may be displayed, which may include a data title or name parameter, preset or predetermined duration of time associated with data capture or recording parameters, etc. A flag or other indicator or pointer of the current state of the user device may be set to indicate the status of any selections associated with the system configuration state 535 and any associated current address or value. Control is passed to operation 835 and process 800 continues.

In operation 835, a determination is made as to whether a user control is selected or any other triggering event associated with executing a function associated with directing away from the system configuration state 535 (FIG. 5) of the user device occurs. If in operation 835 it is determined that a user control designed to leave the system configuration state 535 is selected, control is passed to operation 645 (FIG. 6) and process 600 continues. The determination of operation 835 may be based on several factors. For example, a user control such as a button, switch, voice activation command, or otherwise may be utilized to select any parameter of the system configuration state 535 of the user device. Alternatively, a user control associated with leaving the system configuration state 535 may be selected in operation 835 (FIG. 8), such as, for example, by a selection of an ‘exit’ or ‘cancel’ control, that may return the user device function to a previous state and/or direct the user device function to the default state 505 (FIG. 5). If it is determined in operation 835 that a user control is not selected to leave the system configuration state 535, control is passed to operation 825 and process 800 continues. Alternatively, if no user control is selected to leave the system configuration state 535 in operation 835, the user device may operate a time-out function that may return the user device function to a previous state and/or directs the user device function to another state, for example, the default state 505 (FIG. 5).

As illustrated in FIG. 9, a process 900 for executing any functions associated with the save state 520 (FIG. 5) of a user device is provided. In operation 905, a flag or other indicator of the current state of the user device may be set to indicate the status of the system save state 520 and any associated current addresses or values. For example, a save initialization point may be set to a current address with a value given as the ending point in a previous playback session or current location of a saving pointer or other indicator if the save state 520 was approached by a resting state, such as the default state 505. The current address and value may be set by a saving pointer in the circular or ring buffer of the user device. Alternatively, a subroutine may be associated with the operation 905 which may include obtaining a save starting address and/or value utilizing an input parameter, obtaining a save ending address and/or value utilizing another input parameter and/or designed to obtain a start and/or end address by manual or automatic parameters or unit parameters associated with saving data to the ring buffer and/or storing or archiving data in the DSM. Control is passed to operation 910 and process 900 continues.

In operation 910, any display and/or interface associated with the save state 520 (FIG. 5) may be updated. For example, user controls associated with the save state 535, such as user controls that may facilitate the execution of functions such as selecting and/or changing system save parameters, such as selecting, editing or inputting a data file name, selecting a return to a playback state previously changed from, etc. may be displayed on the user device. In addition, system save parameters and/or any other data may be displayed. Control is passed to operation 915 and process 900 continues.

In operation 915, a determination is made as to whether a user control is selected or any other triggering event associated with initializing input of the save state 520 (FIG. 5) of the user device occurs. If in operation 915 it is determined that a user control is selected, control is passed to operation 920. The determination of operation 915 may be based on several factors. For example, a user control such as a button, switch, voice activation command, or otherwise may be utilized to select any parameter of the save state 520 and/or may be selected to execute a function, such as obtaining data input parameters such as a data file name, size or location associated with the save state 520 (FIG. 5) of the user device. If it is determined in operation 915 that a user control is not selected, control is passed to operation 660 (FIG. 6) and process 600 continues. In an alternative, if it is determined in operation 915 that a user control is not selected, control may not direct away from the save state 520, but may wait at the save state 520, or any other state and continue to wait until a selection occurs.

In operation 920, any display and/or interface, current state, address and/or value associated with the save state 520 (FIG. 5) may be updated. For example, user controls associated with the save state 520, may be displayed on the user device. In addition, a user device may display the current status of a user control selection, by for example displaying any information associated with a selected data parameter of the user device system. For example, any parameters associated with saving a data file may be displayed, which may include a data title or name parameter, preset or predetermined duration of time associated with data capture or recording parameters, etc. A flag or other indicator or pointer of the current state of the user device may be set to indicate the status of any selections associated with the save state 520 and any associated current address or value. Control is passed to operation 925 and process 900 continues.

In operation 925, a determination is made as to whether a user control is selected or any other triggering event associated with executing a function associated with the save state 520 (FIG. 5) of the user device occurs. If in operation 925 it is determined that a user control is selected, control is passed to operation 930 and process 900 continues. The determination of operation 925 may be based on several factors. For example, a user control such as a button, switch, voice activation command, or otherwise may be utilized to select any parameter of the save state 520 and/or may be selected to execute a function, such as obtaining data input parameters such as a data file name, size or location and/or data description or any information associated with a data file associated with the save state 520 (FIG. 5) of the user device. If it is determined in operation 925 that a user control is not selected, control is passed to operation 935 and process 900 continues. Alternatively, a user control associated with leaving the save state 520 may be selected, such as, for example, by a selection of an ‘exit’ or ‘cancel’ control, that may return the user device function to a previous state and/or direct the user device function to the default state 505 (FIG. 5).

In operation 930, any display and/or interface, current state, address and/or value associated with the save state 520 (FIG. 5) may be updated. For example, user controls associated with the save state 520, may be displayed on the user device. In addition, a user device may display the current status of a user control selection, by for example displaying any information associated with a selected data parameter of the user device system. For example, any parameters associated with saving a data file may be displayed, which may include a data title or name parameter, preset or predetermined duration of time associated with data capture or recording parameters, etc. A flag or other indicator or pointer of the current state of the user device may be set to indicate the status of any selections associated with the save state 520 and any associated current address or value. Control is passed to operation 935 and process 900 continues.

In operation 935, a determination is made as to whether a user control is selected or any other triggering event associated with executing a function associated with directing away from the save state 520 (FIG. 5) of the user device occurs. If in operation 935 it is determined that a user control to leave the save state 520 is selected, control is passed to operation 660 (FIG. 6) and process 600 continues. The determination of operation 935 may be based on several factors. For example, a user control such as a button, switch, voice activation command, or otherwise may be utilized to select any parameter of the save state 520 of the user device. Alternatively, a user control associated with leaving the save state 520 may be selected in operation 935 (FIG. 9), such as, for example, by a selection of an ‘exit’ or ‘cancel’ control, that may return the user device function to a previous state and/or direct the user device function to the default state 505 (FIG. 5). If it is determined in operation 935 that a user control is not selected to leave the save state 520, control is passed to operation 925 and process 900 continues. Alternatively, if no user control is selected to leave the save state 520 in operation 935, the user device may operate a time-out function that may return the user device function to a previous state and/or directs the user device function to another state, for example, the default state 505 (FIG. 5).

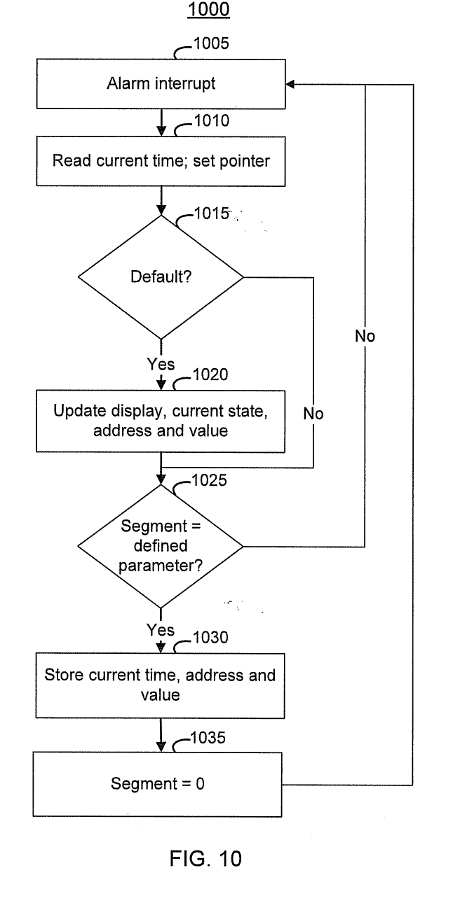

As illustrated in FIG. 10, a process 1000 for executing a subroutine for updating a clock associated with a user device is provided. The process 1000 may be implemented in updating a clock such as an RTC associated with a user device. In addition, the process 1000 may be implemented for updating a time associated with the capturing or recording of data to the circular buffer. For example, any data or information recorded or saved to the circular or ring buffer may be associated with a recording time. A recording time may include any unit of time that along with any other information may be utilized for identification purposes of any data files.

In operation 1005, an alarm interrupt is generated at a predefined measurement or unit of time, for example, an interrupt may be triggered every second. Control is passed to operation 1010 and process 1000 continues.

In operation 1010, a new time is read from the timer control, for example, from an RTC module associated with a user device, and a flag, pointer or other indicator associated with a segment of data associated with the new time is set and/or updated. Control is passed to operation 1015 and process 1000 continues.

In operation 1015, a determination is made as to whether the default state 505 (FIG. 5) is the current state of the user device. If in operation; 1015 it is determined the default state 505 (FIG. 5) is the current state of the user device, control is passed to operation 1020. The determination of operation 1015 may be based on several factors. For example, a user control such as a button, switch, voice activation command, or otherwise may be executed to change a current state of the user device to the default state 505 which may be detected by a state status indicator that may be read by the user device. If it is determined in operation 1015 the default state 505 (FIG. 5) is not the current state of the user device, control is passed to operation 1025 and process 1000 continues.

In operation 1020, any display and/or interface, current state, new time, address and/or value associated with the new time may be updated. For example, user controls associated with the new time, may be displayed on the user device. In addition, a user device may display the current status of a user control selection, by for example, displaying any information associated with a data parameter of the user device system. A flag or other indicator or pointer of the new time of the user device may be set to indicate the time, location and/or status associated with the new time and any associated current address or value. Control is passed to operation 1025 and process 1000 continues.

In operation 1025, a determination is made as to whether a flag or indicator of the new segment of data associated with the new time is equivalent to a system parameter of the user device. If in operation 1025 it is determined that a flag or indicator of the new segment of data associated with the new time is equivalent to a system parameter of the user device, control is passed to operation 1030. The determination of operation 1025 may be based on several factors. For example, a flag or indicator of the new segment of data associated with the new time may be compared to a system parameter, such as for example a defined length or period of time. If it is determined in operation 1025 that a flag or indicator of the new segment of data associated with the new time is not equivalent to a system parameter of the user device, control is passed to operation 1005 and process 1000 continues.

In operation 1030, any display and/or interface, current state, new time address and/or value associated with the new time may be updated and/or saved or stored in an index buffer, or otherwise stored to the user device. A new time and/or address indicator associated with a location in a circular buffer may be stored and/or utilized for a playback selection and/or playback state function. Control is passed to operation 1035 and process 1000 continues.

In operation 1035, a flag or indicator of the new segment of data associated with the new time is reset to null value. Control is passed to operation 1005 and process 1000 continues.

The present disclosure should not be limited to the embodiments described herein. After being presented with the disclosure herein, those of ordinary skill in the art would appreciate that changes may be made to the disclosed embodiments without departing from the spirit and scope of the present disclosure.

What is claimed is:

1. An apparatus, comprising:
an input device capturing an input signal; and
a control device continuously saving the input signal and archiving a designated portion of the input signal that has been saved.

2. An apparatus as recited in claim 1, wherein the control device comprises:
a ring buffer adapted to save the input signal; and
a non-volatile storage adapted to archive the designated portion.

3. An apparatus as recited in claim 2, wherein the control device further comprises a processor saving the input signal in the ring buffer and storing the designated portion from the ring buffer into the storage.

4. An apparatus as recited in claim 3, wherein the control device further comprises a user interface for a user to designate storing the designated portion.

5. An apparatus as recited in claim 4, further comprising an output device outputting the designated portion responsive to a user request via the interface.

6. An apparatus as recited in claim 5, further comprising:
a communication system coupled to the processor; and
a computer system coupled to the communication system and receiving the designated portion from the processor over the communication system.

7. A system, comprising:
an input device capturing an input signal; and
a control device continuously saving the input signal and archiving a designated portion of the input signal that has been saved, the control device comprising:
a ring buffer adapted to save the input signal;
a non-volatile storage adapted to archive the designated portion; and
a processor saving the input signal to the ring buffer and storing the designated portion from the ring buffer into the storage.

8. A portable device carryable by a user, comprising:
an input device capturing an input signal in a vicinity of the user; and
a control device continuously saving the input signal and archiving a designated portion of the input signal that has been saved, the control device comprising:
a ring buffer adapted to save the input signal;
a non-volatile storage adapted to archive the designated portion; and
a processor saving the input signal to the ring buffer and storing the designated portion from the ring buffer into the storage;
a user interface coupled to the processor and including an activation button for the user to designate storing the designated portion where the designated portion is a predetermined period of time prior to a time at which the user activates the activation button; and
an output device coupled to the processor and outputting the designated portion responsive to a user request via the interface.

9. A system, comprising:
an input device capturing an audio video input signal in a vicinity of a user; and
a control device continuously saving the input signal and archiving a designated portion of the input signal that has been saved, the control device comprising:
a ring buffer adapted to save the input signal;
a non-volatile storage adapted to archive the designated portion; and
a processor saving the input signal to the ring buffer and storing the designated portion from the ring buffer into the storage;
a user interface coupled to the processor and including an activation button for the user to designate storing the designated portion where the designated portion is a predetermined period of time prior to a time at which the user activates the activation button; and
an output device outputting the designated portion responsive to a user request via the interface;
a communication system coupled to the processor; and
a computer system coupled to the communication system, receiving the designated portion from the processor over the communication system and storing the designated portion in a database.

10. A system, comprising:
an input device receiving an input signal; and
a control device allowing a user to designated a past portion of the input signal to be saved and saving the designated past portion.

11. A method, comprising:
recording an input signal in a circular buffer; and
saving a portion of the circular buffer responsive to a designation by a user.

12. A method as recited in claim 11, further comprising saving a double length portion responsive to a second designation by the user.

13. A method as recited in claim 11, further comprising allowing the user to set portion parameters including time length of the buffer and a time length of the portion.

14. A data structure, comprising:
a circular buffer storing an input signal captured in a vicinity of a user and having a circular buffer time storage time length; and
a non-volatile storage saving a designated portion of the circular buffer when designated by the user.
